(19) United States
(12) Patent Application Publication
(10) Pub. No.: US 2010/0028215 A1
(43) Pub. Date: Feb. 4, 2010

(54) REAGENT CONTAINER AND REAGENT CAROUSEL

(76) Inventor: Roland Schenk, Kirchheim (DE)

Correspondence Address: GERALD K. WHITE;GERALD K. WHITE & ASSOCIATES, PC, 205 W RANDOLPH STREET SUITE 835, CHICAGO, IL, 60606, US

(21) Appl. No.: 12/312,345

(22) PCT Filed: Nov. 14, 2007
(86) PCT No.: PCT/EP2007/062306

§ 371 Date: Oct. 2, 2009

(30) Foreign Application Priority Data
Nov. 14, 2006 (DE) 20 2006 017 454.0

(51) Int. Cl. B01L 3/00

(52) U.S. Cl. 422/102

(57) ABSTRACT

The present invention concerns a reagent container for liquid reagents comprising a substantially circular sector-shaped, trapezoidal or triangular container bottom and container top and container side walls which extend substantially vertically from the container bottom to the container top and which converge towards each other from a container rear wall to a container front side, wherein the container top has an opening. In order to be able to fit reagent containers of various sizes into a reagent carousel in exactly positioned and reliably fixed relationship it is proposed in accordance with the invention that provided at at least one container side wall of the reagent container is at least one positioning groove or positioning abutment surface which starts from the container bottom and extends vertically in the direction of the container top. In order to be able to use as many different reagent containers as possible for a given reagent carousel there is further proposed a reagent carousel having a substantially circular carousel base surface and compartments which are arranged radially thereon and which are defined by radially extending boundaries, for receiving reagent containers, wherein the boundaries defining a compartment have at least one projection facing towards the compartment interior for engagement with a positioning groove or a positioning abutment surface of a reagent container.

The present invention concerns a reagent container for liquid reagents comprising a substantially circular sector-shaped, trapezoidal or triangular container bottom and container top and container side walls which extend substantially vertically from the container bottom to the container top and which converge towards each other from a container rear wall to a container front side, wherein the container top has at least one closable container opening. Furthermore the invention concerns a reagent carousel having a substantially circular carousel base surface and compartments arranged radially on said carousel base surface for receiving reagent containers, wherein the compartments are defined by radially extending boundaries. Furthermore the invention concerns an automated analysis system having the aforementioned reagent containers and the aforementioned reagent carousel.

As in many other areas, the medical and veterinary-medical diagnostic field is also involving increasing automation of the necessary method steps. In this connection mention is to be made of in particular analysers, that is to say automated analysis systems which remove the various reagents required for carrying out an analysis procedure, from automatically provided reagent containers, and unite such reagents with a substance to be investigated in a reaction vessel for the purposes of carrying out the analysis operation. In part the use of only one reagent is required for carrying out such an investigation. In other analysis procedures, two or more different reagents have to be provided, in some cases in different amounts. Various systems are known for that purpose from the state of the art. One of those systems includes a reagent carousel in which a plurality of reagent containers can be placed, a drive device for performing the rotary movement of the carousel as well as a control device and a pipetting arm.

The reagent carousels known from the state of the art for liquid reagent containers frequently have a substantially circular carousel base surface, with compartments arranged radially on the carousel base surface for receiving the reagent containers. The shape of those compartments is matched to the reagent containers which are respectively used, so that the compartments generally have a circular or rectangular compartment base surface. However, round reagent carousels with compartments in the shape of a sector of a circle are also known, for receiving containers of a corresponding shape.

In the reagent carousels known from the state of the art the compartments for the reagent containers are matched to a respective given type of reagent container, that is to say the base surface of those compartments substantially corresponds to the base surface of the reagent containers which are to be fitted into those compartments.

Accordingly, only those given reagent containers can be fitted into the correspondingly adapted reagent carousels, in such a way as to permit satisfactory operation of the analyser. It is to be noted in that respect that, in the case of the automated analysis systems with a pipetting arm, very high demands are placed on precise positioning of the reagent containers so as to ensure that the pipetting arm discovers the reagent container and in particular the opening for reagent removal precisely at the pre-programmed position. In view of the in part very small openings in the reagent containers for reagent removal, extremely small tolerances are desired for positioning of the reagent containers and their openings. If a reagent container which does not completely fill up the compartment base surface is fitted into the compartment of a reagent carousel, that can lead to incorrect positioning and to problems in reagent removal. Consequently it is only possible to fit into the compartments of the reagent carousels known from the state of the art, those reagent containers whose shape is exactly matched to that of the compartments.

As the analysis operations carried out with an analyser frequently require different volumes of reagents however it would be desirable to be able to receive different reagent containers with one and the same reagent carousel, in which case it is necessary to ensure that the reagent containers are exactly positioned and are also reliably held in that position during operation of the analyser. A system would be particularly advantageous, in which as many different reagent containers as possible can be suitably positioned in the reagent carousel.

There is therefore a need for reagent containers of different sizes, which are suitable for receiving one or more reagents and which can be fitted into the same reagent carousel for carrying out different tests and experiments. In that respect the reagent containers should be so designed that they are exactly positioned in the reagent carousel and are also reliably fixed in that position during operation. Overall there is a need for a system which affords the highest possible level of flexibility in terms of selection of the reagent containers for a given reagent carousel without any need to have in readiness a second carousel involving a compartment size different from the first carousel.

That object is attained by reagent containers for liquid reagents of the kind set forth in the opening part of this specification, which are characterised in that provided at at least one container side wall is at least one positioning groove or positioning abutment surface which starts from the container bottom and extends vertically in the direction of the container top.

The reagent containers according to the invention have the advantage that they have a positioning groove or positioning abutment surface extending substantially perpendicularly over at least one of the container walls. That positioning groove or positioning abutment surface makes it possible for a reagent container according to the invention to be fitted into the compartment of a reagent carousel by the provision of a projection which extends into the interior of the compartment and which is so arranged that it engages into the groove or bears against the abutment surface of the reagent container. The engagement or abutment relationship is preferably in positively locking relationship and/or force-locking relationship.

Engagement or abutment of the projection with or against the groove or abutment surface provided on the reagent container in accordance with the invention provides that the reagent container is guided into the desired position in the compartment and fixed in that position. In that way even those reagent containers which do not occupy the entire compartment base surface can be fitted in the corresponding carousel compartment in a stable position. When the reagent containers are correspondingly fitted in position and fixed by engagement or abutment of the projection and the groove or the abutment surface respectively, that ensures that they always remain in operation in the position in which they were originally fitted, thereby ensuring that the container opening in the container top is always in the position in which the pipetting arm of an analyser is intended to pass into the container to remove the reagent.

The terms ‘groove’ or ‘positioning groove’ in the context of the present invention denote any recess or depression which extends substantially perpendicularly over a container side wall and into which a projection of suitable configuration which projects into the interior of the compartment, on the reagent carousel (for example a pin or a bar) can engage.

The terms ‘abutment surface’ or ‘positioning abutment surface’ in the context of the present invention denote an abutment surface in the region of the transition from a container side wall to the container front side or the container rear wall. Preferably the abutment surface is in the form of a bevel at the transition of at least one container side wall to the container front side, particularly preferably at the transition of both side walls to the container front side.

Preferably provided at both container side walls is at least one respective positioning groove or positioning abutment surface which starts from the container bottom and extends vertically in the direction of the container top. A particularly good fixing is achieved in that way. In preferred embodiments, the positioning grooves or positioning abutment surfaces provided at both container side walls are arranged at an equal spacing from the container rear wall. Alternatively the positioning grooves provided at both container side walls are arranged at a different spacing from the container rear wall.

In an embodiment of reagent containers according to the invention at least one positioning groove or positioning abutment surface is also additionally provided at the container rear wall and/or container front wall for engagement with or abutment against corresponding projections in reagent carousels according to the invention.

In an embodiment of reagent containers according to the invention the positioning grooves or positioning abutment surfaces terminate starting from the container bottom at a spacing relative to the container top. In an alternative embodiment the positioning groove or positioning abutment surface extends from the container bottom to the container top. That provides for particularly good guidance and fixing of the reagent container upon being fitted into the compartment and during operation as engagement is afforded, over the entire container wall, with the projection of the reagent container, that projects into the compartment interior.

In a particularly preferred embodiment of the invention the at least one positioning groove is provided in the form of an inwardly curved portion, that inwardly curved portion extending into the container interior. The advantage of this embodiment is that the reagent container walls can be very thin as the positioning groove provided in accordance with the invention is not restricted in its depth to the thickness of the container wall but can also extend in the configuration of an inwardly curved portion, into the container interior. Overall that makes it possible to achieve a larger internal volume for the reagent container as the container can make optimum use of the compartment volume of the reagent carousel.

In further preferred embodiments the container has at least one separating wall or constriction subdividing the container interior into at least two separate chambers. Preferably a substantially perpendicularly extending constriction is provided in at least one container side wall, the at least one constriction extending through the container interior to the respectively opposite side wall whereby the container interior is subdivided into two separate containers. It is particularly preferred if two mutually opposite constrictions of the container side walls meet each other in the container interior. Subdivision of the reagent container interior by means of constriction of the container side wall or walls affords containers having a plurality of chambers, referred to as twin containers, triple containers or multiple containers. Such multiple containers have the advantage that various reagents can be separately fitted into a carousel compartment with a single container so that a pipetting arm in a reagent carousel position can remove two or more reagents required for carrying out a test or experiment. In a particularly preferred feature the constrictions or separating walls are provided in the reagent container in such a way that the separate chambers of the container interior are of different volumes, the ratio of the volumes to each other preferably being 3 to 5:1. That is advantageous as reagents for analysis operations are frequently required in differing amounts, so that the reagents in the containers according to the invention can be provided in such a way as to correspond to their probable consumption, without having to only partially fill chambers of the reagent container or, after consumption of the reagent of which a greater amount is required, having to discard the other reagent or reagents.

In a further embodiment of the invention the constriction for separation of the container interior into a plurality of chambers and the positioning groove coincide, that is to say a constriction at the same time represents the positioning groove.

In a particularly preferred embodiment of the reagent container according to the invention it has precisely two separate containers.

Preferred reagent containers of the aforementioned kind are characterised in that for access to each of the chambers there is provided a closable container opening in the container top so that reagent can be introduced and removed from each separate chamber through those openings. Alternatively an individual chamber or a plurality of the chambers may have no container opening, in which case the chambers without container openings are denoted by what are referred to as blind chambers.

If a reagent container has two or more closable container openings in the container top they are desirably at a spacing relative to each other of 0.1 to 2 cm. The upper limit of 2 cm affords the advantage that the pipetting arm only has to cover a short distance for taking reagent from both container openings. That means that the required size of the pipetting arm is also reduced overall. That leads both to a saving in material and also a saving in time in operation and a reduction in the dead volume of the analyser. The minimum spacing of 0.1 cm has the advantage that a closure of the closable container openings can still be readily gripped by hand or an automated device without interfering with the adjacent container opening. Preferably the spacing between two closable container openings is 0.3 to 1 cm and quite particularly preferably 0.4 to 0.5 cm if the closure for the container opening is a screw closure which is to be gripped by an automated device and opened or closed by rotation.

Depending on the reagents introduced into the reagent containers the reagent container preferably comprises a material which is either permeable or impermeable for beams or light. Particularly preferably the reagents container comprises a fracture-resistant material. In addition the material is preferably chemically inert and resistant to heat, acids, lyes and radiation. Particularly preferred reagent containers are made from plastic material, preferably using an extrusion blow moulding method.

For the purposes of further automation, it is particularly preferable if provided on the reagent container is an optically, electronically or mechanically detectable marking, by way of which an operator and/or the analyser device can obtain information. Such information concerns for example the size and structure of the reagent container such as the number of chambers, the volume of the individual chambers and so forth, as well as the content of the individual chambers of the reagent container. Preferably the detectable marking comprises a barcode or a transponder.

The reagent carousel according to the invention has a substantially circular carousel base surface and compartments arranged radially on that carousel base surface, for receiving the reagent containers according to the invention, wherein the compartments are delimited by radially extending boundaries which have at least one projection facing towards the compartment interior for an engagement with a positioning groove or a positioning abutment surface of a reagent container.

The reagent containers according to the invention are fixed in the compartments of the reagent carousel, which are provided for receiving the reagent containers, more specifically even when the reagent containers do not completely fill up the compartment. In that way it is possible for various reagent containers in accordance with the invention to be fitted into the reagent carousel without the reagent containers in operation changing their position so that a pipetting arm always discovers an opening provided in the reagent containers, at the programmed location.

Preferably the boundaries which define the extent of a compartment in the radial and lateral directions are in the form of separating walls, from which projections for engagement or abutment with the positioning grooves or positioning abutments of the reagent containers extend into the interior of a respective compartment. Alternatively the boundaries can also be in the form of an apertured plate having openings which correspond to the base surface of the compartments, wherein said apertured plate is arranged over the carousel base surface and substantially parallel thereto. In that case the projections which in accordance with the present invention project into the interior of a respective compartment are provided on that apertured plate and project into the openings provided in the apertured plate.

In a preferred embodiment, for each compartment, there are provided two projections facing from opposite sides in the direction of the reagent container, in the form of pins or bars, for engagement or abutment with corresponding positioning grooves or positioning abutments of a reagent container. The more vertically arranged pins there are provided, or the longer the respective bar is, the correspondingly better is the guidance effect when fitting a reagent container into the reagent carousel. In addition optimum fixing is also ensured in operation in that fashion.

Preferably the reagent carousel according to the invention is in one piece and in particular is in the form of an injection moulding.

The automated analysis system according to the invention includes a reagent carousel of the above-described kind and interchangeable reagent containers according to the invention.

Preferably the liquid containers are of such dimensions that they occupy substantially the entire compartment base surface. In alternative embodiments of the analysis system according to the invention the liquid containers are of such dimensions that they only occupy a part of the compartment base surface, wherein the region occupied by the liquid container extends between the radially outer or the radially inner boundary of a compartment in the reagent carousel and projections, pins or bars at the lateral compartment boundary for abutment with corresponding positioning abutments on the reagent container. That embodiment has the advantage of a saving on material in relation to reagent containers for smaller reagent volumes.

The analysis system according to the invention permits extremely flexible use of various liquid containers in one and the same reagent carousel. Thus it is possible to use in a carousel both single-chamber liquid containers according to the invention which extend over the entire compartment base surface and also single-chamber liquid containers which extend between a projection and a radially outer or radially inner boundary of a compartment in the reagent carousel. Furthermore it is possible to use liquid containers which are of a two-chamber construction, wherein the reagent container can extend both over the entire compartment base surface and also only in a part between a projection and a radial boundary. Furthermore it is also possible to use multi-chamber reagent containers which are disposed only in a part of the compartment, that is defined by a projection, or which fill up the entire compartment, in which case chamber can also be in the form of blind chambers, that is to say without an opening. What is essential in relation to all reagent containers is that they can be fitted into the analysis system according to the invention without an adaptor and in a stable position. That affords many different combination options in practical application. Furthermore the system according to the invention does not require the provision of springs or the like which are susceptible to wear, in order for example to fix smaller containers in the compartments.

The crucial advantages, besides the high flexibility required, are a) the saving in terms of providing different carousels for different applications, b) the possibility of using reduced-length reagent containers without adaptors or springs which are susceptible to wear having to be additionally fitted, and c) the possibility of simultaneous use of different reagent containers in a carousel. The possibility of using reduced-length reagent containers also serves for saving on material costs in production of the reagent containers. That is a quite substantial point as the liquid containers involve consumable materials which are usually only used once and which are discarded after consumption of the reagents.

Further preferred features and combinations of features of the present invention will be apparent from the accompanying Figures and the description hereinafter of the Figures in which:

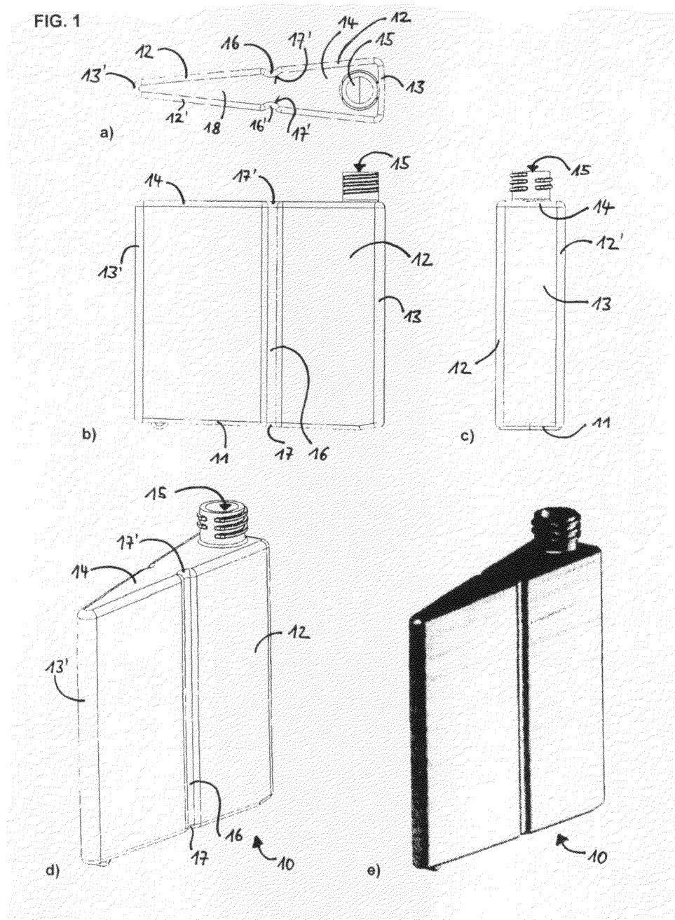

FIG. 1 shows various views and illustrations of an embodiment of a single-chamber reagent container according to the present invention,

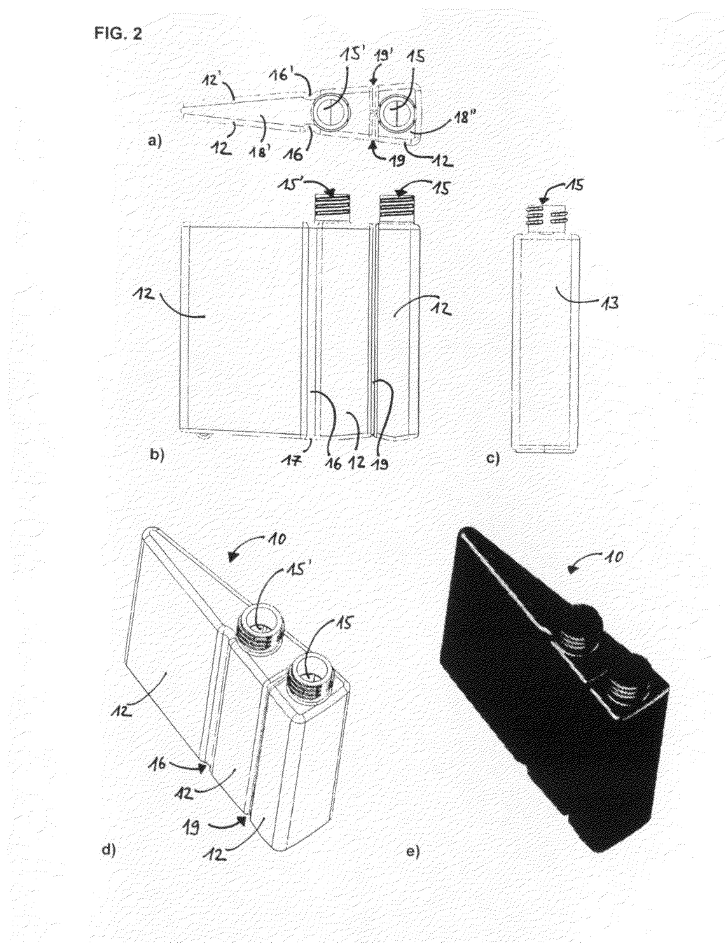

FIG. 2 shows various views and illustrations of an embodiment of a dual-chamber reagent container according to the present invention,

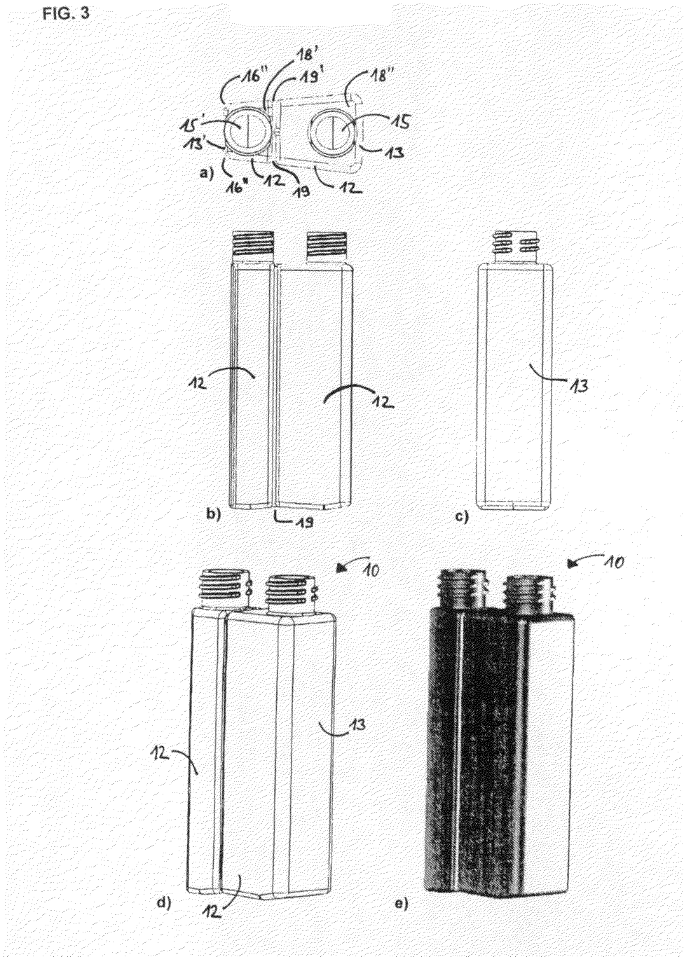

FIG. 3 shows various views and illustrations of an embodiment of a reduced-length dual-chamber reagent container according to the present invention,

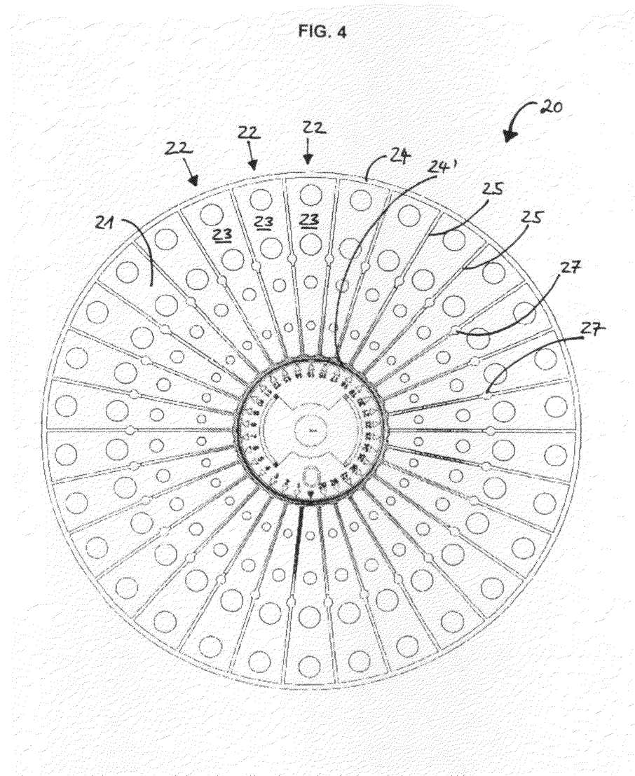

FIG. 4 shows a plan view from above of an embodiment of a reagent carousel according to the invention, and

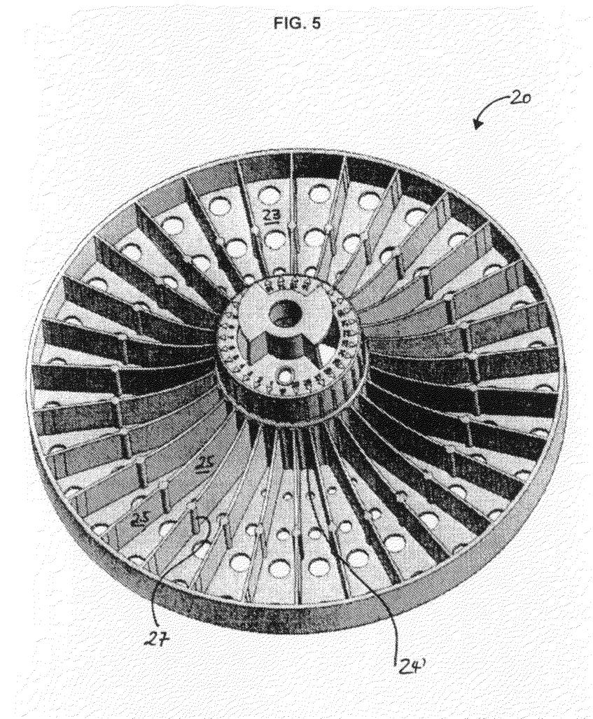

FIG. 5 shows a perspective view inclinedly from above illustrating the reagent carousel of FIG. 4.

FIGS. 1a) to d) are graphic representations of a reagent container according to the present invention from various views, the illustrated reagent container being a single-chamber embodiment.

FIG. 1a) shows a view of the reagent container 10 from above. This view shows the container top 14, the side walls 12 and 12′ as well as the container rear wall 13 and also the container front wall 13′. In the view from above the reagent container shown in this Figure is of a substantially triangular cross-section. An opening 15 is provided in the container top 14. It is also possible to see from this view that the container top 14 has recesses 17 which continue into positioning grooves 16, 16′. The positioning grooves 16, 16′ are in the form of part of the side walls 12, 12′ and project into the container interior.

FIG. 1b) is a side view of the embodiment of this reagent container. It will be seen from this Figure that the positioning groove 16 extends substantially vertically over the entire container side wall 12 and also opens on the underside into a recess 17 in the container bottom 11. It can also be seen from this view that the opening 15 has a screwthread. Accordingly in this embodiment the opening 15 is closable with a screw lid.

FIG. 1c) shows a plan view of the container rear wall 13 of the reagent container. FIG. 1d) is a perspective view of the reagent container. FIG. 1e) is a three-dimensional representation of the view of the reagent container according to the invention as shown in FIG. 1d).

FIG. 2 includes various views of a graphic representation of a dual-chamber reagent container according to the invention as well as a three-dimensional view (FIG. 2e) of this embodiment. Views a) to c) are selected as in FIG. 1. The perspective views of illustrations d) and e), in contrast to the corresponding illustrations in FIG. 1, are not shown inclinedly from the front and the top, but inclinedly from the rear and the top.

FIG. 2a) shows substantially the same features as already described for FIG. 1. In addition the embodiment in FIG. 2 has a constriction 19 in the side wall 12 and a constriction 19′ in the side wall 12′. Those constrictions 19, 19′ are in mutually opposite relationship and meet in the centre of the reagent container whereby the reagent container is subdivided into two separate chambers 18, 18′. The two chambers 18, 18′ each have a respective screwable opening 15, 15′.

FIG. 3 shows graphic and three-dimensional illustrations a) to e) of a reduced-length, dual-chamber reagent container according to the invention. By virtue of the reduction in length the base surface of the reagent container is substantially trapezoidal. In this embodiment also the reagent container 10 is subdivided into two chambers 18, 18′ by constrictions 19, 19′ in the side walls 12. As also in the embodiment of FIG. 2, both chambers 18, 18′ are provided with closable openings 15, 15′. A particularity with this embodiment is that it has positioning abutment surfaces 16″ which are substantially in the form of a bevel at the edge at the transition of the side walls 12 into the front wall 13′.

FIG. 4 is a plan view from above showing an embodiment of a reagent carousel 20. The Figure shows inter alia the carousel base surface 21 and the compartments 22 which are arranged radially on the carousel base surface and which are adapted to receive reagent containers according to the invention. The compartments 22 have a substantially triangular to circular sector-shaped compartment base surface 23. In their radial extent, the compartments 22 are defined in the direction of the carousel centre point by the radial boundary 24′ and outwardly by the radial boundary 24. At the sides the compartments 22 are defined by the lateral boundaries 25. Bars 27 projecting into the interior of the compartments are provided on the lateral boundaries. Those bars 27 are of such a configuration that they come into engagement with the grooves 16, 16′ or abutment surfaces 16″, provided on the reagent containers according to the invention. The illustrated reagent carousel is in one piece in the form of an injection moulding.

FIG. 5 shows a perspective view of the FIG. 4 embodiment of a reagent carousel according to the invention. Besides the features which can already be seen from FIG. 4 the FIG. 5 view additionally shows the configuration of the radial and lateral boundaries 24, 24′ and 25 in the form of separating walls as well as the configuration of the projection 27 in the form of a continuous bar which extends substantially perpendicularly from the carousel base surface 21, over the entire height of the lateral boundary 25.

There is no joint representation herein of a reagent carousel and reagent container in an automated analysis system according to the present invention as all possible options in terms of the combination of reagent containers according to the invention in the reagent carousel according to the invention are apparent to the man skilled in the art, and a corresponding representation is not necessary to understand the invention. It is thus clear to the man skilled in the art that the reagent carousel of FIGS. 4 and 5 can be fitted both with reagent containers of the embodiment of FIG. 1 and also with reagent containers of the embodiments shown in FIGS. 2 and 3. It is further apparent that the reagent carousel of FIGS. 4 and 5 can be simultaneously fitted with reagent containers of one type and also with reagent containers of the various types according to the invention.

### LIST OF REFERENCES

10 reagent container
11 container bottom
13 container rear wall
13′ container front side
12, 12′ container side walls
14 container top
15, 15′ container opening
16, 16′ positioning groove
16″ positioning abutment surfaces
17, 17′ recess
18 container interior
18′, 18″ chamber
19, 19′ constriction
20 reagent carousel
21 carousel base surface
22 compartments
23 compartment base surface
24, 24′ radial boundary
25, 25′ lateral boundary
27 projection

1. A reagent container (10) for liquid reagents comprising a substantially circular sector-shaped, trapezoidal or triangular container bottom (11) and container top (14) and container side walls (12, 12′) which extend substantially vertically from the container bottom (11) to the container top (14) and which converge towards each other from a container rear wall (13) to a container front side (13′), wherein the container top (14) has at least one closable container opening (15), characterised in that provided at least one container side wall (12, 12′) is at least one positioning groove (16, 16′) or positioning abutment surface (16″) which starts from the container bottom and extends vertically in the direction of the container top (14).

2. A reagent container according to claim 1 characterised in that provided at both container side walls (12, 12′) is at least one respective positioning groove (16, 16′) or positioning abutment surface (16″) which starts from the container bottom and extends vertically in the direction of the container top (14).

3. A reagent container according to claim 2 characterised in that the positioning grooves (16, 16′) or positioning abutment surfaces (16″) provided at both container side walls (12, 12′) are arranged at an equal spacing from the container rear wall (13).

4. A reagent container according to claim 2 characterised in that the positioning grooves (16, 16′) provided at both container side walls (12, 12′) are arranged at a different spacing from the container rear wall (13).

5. A reagent container according to claim 1 characterised in that the positioning grooves (16, 16′) or positioning abutment surfaces (16″) extend from the container bottom to the container top (14).

6. A reagent container according to claim 1 characterised in that the positioning grooves (16, 16′) or positioning abutment surfaces (16″) terminate starting from the container bottom at a spacing relative to the container top (14).

7. A reagent container according to claim 1 characterised in that the container has at least one separating wall or constriction (19) subdividing the container interior (18) into at least two separate chambers (20, 20′).

8. A reagent container according to claim 7 characterised in that for access to each of the chambers (20, 20′) there is provided a closable container opening (15, 15′) in the container top (14).

9. A reagent container according to claim 7 characterised in that the container has precisely two separate chambers (20, 20′) with a ratio of the internal volumes of 3 to 5:1.

10. A reagent container according to claim 9 characterised in that two closable container openings (15, 15′) in the container top (14) are at a spacing relative to each other of 0.1 to 2 cm, preferably 0.3 to 1 cm, particularly preferably 0.4 to 0.5 cm.

11. A reagent container according to claim 1 characterised in that the reagent container is made from plastic material and preferably in an extrusion blow moulding method.

12. A reagent container according to claim 1 characterised in that provided on the reagent container is an optically, electronically or mechanically detectable marking, preferably a barcode or transponder.

13. A reagent carousel (20) having a substantially circular carousel base surface (21) and compartments (22) arranged radially on said carousel base surface for receiving reagent containers (10), wherein the compartments are defined by radially extending boundaries (25), characterised in that the boundaries (25) defining a compartment (22) have at least one projection (27) facing towards the compartment interior for an engagement with a positioning groove (16, 16′) or a positioning abutment surface (16″) of a reagent container (10).

14. A reagent carousel according to claim 13 characterised in that the boundaries (25) defining a compartment (22) are provided in the form of separating walls.

15. An automated analysis system comprising a reagent carousel (20) according to claim 13 and interchangeable reagent containers (10) according to claim 1.
